(19) United States
(12) Patent Application Publication
(10) Pub. No.: US 2024/0001179 A1
(43) Pub. Date: Jan. 4, 2024

(54) METHOD FOR FIRE-RESISTANT SEALING OF LINE FEEDTHROUGHS OF THIN PIPES, A SEAL ASSEMBLY PREFABRICATED FOR THIS PURPOSE AND METHOD FOR THE PRODUCTION THEREOF

(71) Applicant: Hilti Aktiengesellschaft, Schaan (LI)

(72) Inventors: Uwe-Michael Bohn, Kissing (DE); Michael Drexl, Schondorf (DE); Julia Förster, Wiedergeltingen (DE)

(73) Assignee: Hilti Aktiengesellschaft, Schaan (LI)

(21) Appl. No.: 18/251,394

(22) PCT Filed: Oct. 20, 2021
(86) PCT No.: PCT/EP2021/079078

§ 371 Date: May 1, 2023

(30) Foreign Application Priority Data
Nov. 2, 2020 (EP) 20205113.2

(51) Int. Cl. A62C 2/06; F16L 5/04

(52) U.S. Cl. CPC A62C 2/065; F16L 5/04

(57) ABSTRACT

A method can be used for fire-resistant sealing of an opening in a wall or ceiling, through which a line is passed. The method involves cutting a strip-shaped fire protection bandage to a length corresponding to a circumference of the line, with or without an overlap. The fire protection bandage contains fire-retardant and/or intumescent material. The method then involves placing the cut-to-length fire protection bandage around the line, to form a layer which only partially protrudes outward from the opening. The method further involves annularly applying a putty to part of the fire protection bandage protruding from the opening, to form a putty ring of a slightly larger outer diameter than the opening diameter, such that the putty ring closes the opening and extends slightly beyond the edge. The method finally involves pressing the putty ring against the fire protection bandage and the opening edge, to seal the line feedthrough.

### TECHNICAL FIELD

The invention relates to a method for fire-resistant sealing of an opening, through which a line is passed, in known substrates such as aerated concrete, drywall, timber constructions and many more, for example in a wall or ceiling of a building or another room. The invention also relates to a seal assembly prefabricated for the same purpose and to a method for the production thereof.

### TECHNICAL BACKGROUND

Fire protection products designed for pipe and cable installations having a diameter of more than 32 mm are known from the prior art, such as an approximately 125 mm wide fire protection bandage having an outer carrier layer or woven fabric layer and an intumescent material applied thereto, which bandage is placed in two layers around the pipe to be sealed off in the region of the opening. Such a fire protection bandage is known, for example, under the name “fire protection bandage CFS-B,” which is also used here for this purpose. In order to seal the opening, additional fastening means and sealing means, including acrylate sealing compounds, are used. Empty electrical conduits in the diameter range of up to 16 mm are usually covered with a standard test configuration.

Fire protection for small or thin pipes in the in-between diameter range (16 mm<Ø<32 mm) is usually not specifically taken into account in the innovative solutions in the prior art of this type and also is not sufficiently represented in the generally recognized verification of the technical usability of a construction product in accordance with the Construction Products Regulation in the member states of the EU, which verification is known as the European Technical Assessment (ETA). Common uses in this diameter range are mainly lines of underfloor heating systems, but also small supply lines in laboratories, for example. Further examples include flexible electrical installation pipes, which are usually occupied by control lines of building services systems.

A conventional fire protection bandage, such as CFS-B, is suitable for use as an intumescent product due to simple processing; however, the required double-layer installation is usually oversized, especially since the mounting has to take place on both sides of the seal, i.e. on both sides of the passage opening to be sealed in a fire-resistant manner.

Currently, in order to construct a seal (i.e. a fire-resistant seal) of a line feedthrough that meets the legal requirements for approval, a sealing product is usually used in said pipe diameter range of between 16 mm and 32 mm, as would be necessary for larger pipes. That is to say, the technical solutions which are currently available are oversized for this field of application. In addition, the installation said technical solutions is usually accompanied by the use of acrylate sealants, which constitute a wet installation and are therefore in principle unclean and involve drying times.

Therefore, for the diameter range of pipes or other lines of between 16 mm and 32 mm, there is no economical and easy-to-install solution for the fire-resistant sealing of the line feedthrough in a wall or ceiling, which solution has the same performance characteristics of up to EI120 (according to EN fire resistance classes for integrity, heat barriers or thermal insulation under the influence of fire) as the currently comparable products for pipes having larger diameters, such as the fire bandage CFS-B together with the associated prescribed sealing agents.

The object of the present invention is that of providing a method for fire-resistant sealing of a line feedthrough, which is an economical and easy-to-install solution, in particular for the diameter range of pipes or other lines between 16 mm and 32 mm, and in particular has the same performance characteristics of up to EI120 (see above) as the comparable conventional products for pipes having larger diameters, for example the fire bandage CFS-B (see above) together with the associated prescribed sealing means. It is also an object of the invention to provide a corresponding prefabricated seal assembly and a method for the production thereof.

### DISCLOSURE OF THE INVENTION

This object is achieved by a method for fire-resistant sealing of a line feedthrough in a ceiling or wall according to claim 1 and by a method for fire-resistant sealing of a line feedthrough in a ceiling or wall using a prefabricated seal assembly, a corresponding seal assembly, and a method for the production thereof according to the additional independent claims. Further embodiments are specified in the dependent claims. All of the additional features and effects mentioned in the claims and the description for the relevant method, in particular features and effects of the suitable materials and the geometric arrangement of individual components of the seal, can also apply to the relevant other method, the seal assembly and the production thereof, and vice versa.

According to a first aspect, a method is provided for fire-resistant sealing of an opening (line feedthrough) through which a line is passed in a wall or ceiling of a building or another space. First, a strip-shaped fire protection bandage is provided which comprises fire-retardant and/or intumescent material and can be, for example, a conventional, commercially available roll product. Said fire protection bandage can be, for example, the conventional fire protection bandage CFS-B mentioned at the outset. The fire protection bandage is then cut to length, i.e. cut off, to a length which corresponds to a simple circumference of the line to be sealed, with or without a slight overlap. The slight overlap can, for example, be less than a tenth of the circumference of the line and can be used to ensure that the fire protection bandage can be placed around the line in a single continuous layer without interruptions and/or that the ends of the fire protection bandage that meet in the circumferential direction can be connected to one another.

The cut-to-length fire protection bandage is then placed around the line such that a simple layer of the fire protection bandage is formed, optionally with the slight overlap in the circumferential direction. In this case, the fire protection bandage is applied to the line in such a way that a large part of the fire protection bandage, in particular at least half of the width thereof, lies within the opening in the wall/ceiling, and only the remaining width protrudes from the opening. The extent to which the fire protection bandage protrudes into or out of the opening can vary depending on the use, in particular depending on the wall thickness and/or the line diameter.

A putty is then annularly applied to the part of the fire protection bandage protruding from the opening such that a putty ring (in particular approximately in the shape of a disc or a circular ring, a regular shape not being important) having a slightly larger outer diameter than the opening diameter is formed or shaped by kneading. The putty ring is shaped such that it closes the opening, i.e. the annular gap between the line and the opening edge, on the outside and extends slightly beyond the opening edge in the ceiling or wall. In other words, the putty ring formed in this way covers the annular gap and is pressed against both the fire protection bandage and the opening edge, as a result of which the line feedthrough is sealed.

In this way, a fire-resistant seal can be constructed in a simple and clean manner, in particular also subsequently and/or over a regular or irregular opening of any geometry.

A suitable putty is ideally plastically deformable in order to be adaptable to the relevant individual shape of the annular gap between the line and the opening edge by kneading in order to seal said gap. The putty can also be dense and/or optionally can also be adhesive. The latter is not a mandatory requirement, however, as the putty ring can already be sufficiently attached to the line feedthrough simply by pressing against the fire protection bandage around the pipe on one side and the wall or ceiling on the other side, and additionally, for example, by partially pressing the putty into the annular gap therebetween.

The putty can be, for example, a crosslinked rubber-based rubber product. In particular, said putty can be a permanently plastic butyl rubber mixture.

In order to improve the fire protection properties, the putty can in particular also contain fire protection additives. The putty can, for example, be flame-retardant or intumescent, such that it foams up when exposed to heat and can thus close defects in the opening that arise in the event of a fire, for example as a result of a melting line.

The method is characterized by a very low processing effort and tool outlay. The method can basically be carried out simply and quickly by hand. The resulting seal is immediately functional: no additional drying times and no additional sealing compounds are required. In particular, this can mean a significant simplification in comparison to the conventional methods mentioned at the outset.

In particular, the method is ideally designed and dimensioned for the fire-resistant sealing of a line feedthrough where the line, for example a pipe or cable, has a diameter in a range of between approximately 16 mm and approximately 32 mm. The necessary material requirements can be directly adapted to the pipe or cable diameter and the size of the opening in the wall or ceiling, which is very resource-efficient. The conventional type of fire protection bandage, which is typically available as a roll product, can be directly adapted to the pipe or cable diameter and the size of the opening in the wall or ceiling by being cut to length. As an exemplary embodiment described in detail below shows, material savings of approx. 88% can be achieved in comparison to a known installation solution using CFS-B, which is designed for a thicker line and requires a double layer of the fire protection bandage which has a width which is many times greater.

According to a further aspect of the invention, a method is provided for producing a seal assembly for fire-resistant sealing of an opening through which a line is passed (line feedthrough) in a wall or ceiling of a building or another space. The method comprises the following steps:

First, a strip-shaped fire protection bandage is provided which comprises fire-retardant and/or intumescent material and can be, for example, a conventional, commercially available roll product. Said fire protection bandage can be, for example, the conventional fire protection bandage CFS-B mentioned at the outset. The fire protection bandage is then cut to length, i.e. cut off, to a length which corresponds to a simple circumference of the line to be sealed, with or without a slight overlap. The slight overlap can be, for example, less than a tenth of the circumference of the line and can be used to ensure that the fire protection bandage can be placed around the line in a single continuous layer without interruptions and/or that the ends of the fire protection bandage that meet in the circumferential direction can be connected to one another.

A putty strip is then applied along one of the two edges of the cut-to-length fire protection bandage, which are intended to extend in the circumferential direction of the line. For this purpose, the putty, in the form of a thick strip, is pressed against or otherwise attached to said edge on an outer surface of the fire protection bandage that is not intended to be placed on the line. The putty strip should have a sufficient thickness and width to cover and seal an annular gap between the line and an opening edge of the line feedthrough to be sealed using the putty contained therein.

The fire protection bandage provided with the putty strip can then optionally be rolled up to form a simple layer which is designed to be placed on the line to be sealed and for this purpose has an almost identical, only slightly larger inner diameter than the circumference of the line. In this case, the ends of the fire protection bandage that overlap in the circumferential direction can be temporarily attached to one another, for example, by some of the putty strip or by further putty.

Alternatively or additionally, a removable transport protection film can optionally be applied to at least one surface of the putty strip in order to protect the putty strip from mechanical damage or from accidentally adhering to surfaces which are not intended for this purpose when transporting the seal assembly and/or when attaching the seal assembly to the line feedthrough to be sealed.

The resulting seal assembly is prefabricated for the following method for fire-resistant sealing of a line feedthrough:

According to a further aspect of the invention, a method is provided for fire-resistant sealing of a line feedthrough using a prefabricated seal assembly of the type described herein. The method comprises the following steps:

The prefabricated seal assembly as described is placed around the line such that a layer of the fire protection bandage is formed on the line, optionally with an overlap, the peripheral edge of the fire protection bandage provided with the putty strip protruding outward from the opening. Before or after this step, an optionally present transport protection film is removed from the putty strip.

The putty strip is shaped to form a putty ring (in particular approximately in the shape of a disc or a circular ring, a regular shape not being important) having a slightly larger outer diameter than the opening diameter by kneading, such that the putty ring closes the opening and extends slightly beyond the edge thereof. The putty ring is thereby and/or subsequently pressed against the fire protection bandage and the opening edge, such that the line feedthrough is sealed. Furthermore, everything described above for the method according to the first aspect applies mutatis mutandis to this method.

In particular, the sealing of the line feedthrough can be carried out in a single mounting step using such a prefabricated seal assembly, as, in contrast to the method according to the first aspect of the invention described above, the fire protection bandage is already cut to length according to the circumference of the line and provided with the putty in this case.

In all aspects, a core of the invention is a simple sealing of thin pipes and other lines by means of a combination of a fire protection bandage (also referred to as a fire protection mat) with a suitable putty, which combination is prefabricated or arranged one after the other during mounting.

In particular, the fire protection bandage can have a flexible carrier layer, for example a woven fabric layer, to which an, in particular continuous, fire protection wrap made of an intumescent material is attached. In particular, such a fire protection bandage with the fire protection wrap thereof can be applied to the line, and the putty can be applied to and pressed against the carrier layer facing away from the line.

In particular, the fire protection bandage can be cut to a reduced width of approximately 30 mm before or after being cut to length.

In particular, the fire protection bandage can protrude approximately 5 cm outward from the opening after being placed around the line.

According to another aspect of the invention a prefabricated seal assembly is provided for fire-resistant sealing of an opening through which a line is passed (line feedthrough) in a wall or ceiling of a building or another space. As described, inter alia, above and below, this seal assembly of the type described herein comprises a strip-shaped fire protection bandage having a length that corresponds to a simple circumference of the line, with or without a slight overlap, the fire protection bandage comprising fire-retardant and/or intumescent material. The seal assembly further comprises a putty strip which extends along one of the two peripheral edges of the fire protection bandage and is applied to an outer surface of the fire protection bandage that is not intended to be placed on the line.

In an advantageous variant of the seal assembly according to the invention, the seal assembly is designed as an in particular prefabricated roll product, which is designed for use for in particular a plurality of pipes.

Optionally, the seal assembly can also have a removable film on at least one surface of the putty strip, which film is in particular designed as a separating film or protective film.

This is particularly advantageous in the case of a seal assembly designed as a roll product, in order to prevent the putty from coming into contact with the bandage in the case of more than one roll winding in the desired circumference.

Alternatively or additionally, the cut-to-length fire protection bandage provided with the putty strip can optionally be rolled up to form a simple layer having an overlap, overlapping ends of the fire protection bandage being attachable to one another, for example, by some of the putty strip or by additional putty.

### BRIEF DESCRIPTION OF THE DRAWINGS

The above aspects of the invention and the embodiments and specific configurations thereof are explained in more detail below with reference to the examples shown in the accompanying drawings. The drawings are kept schematic. Said drawings may, but do not have to, be understood to be true to scale. Identical reference symbols are used therein to denote identical elements or elements which correspond to one another in terms of the function thereof. In the drawings:

FIG. 1a-c show individual steps of a method according to the first aspect of the invention for sealing an opening in a wall through which a thin pipe is passed;

FIG. 2 shows an example of a seal assembly of the type described herein for use in a method according to another aspect of the invention; and

FIG. 3 shows another example of a seal assembly of the type described herein.

### DESCRIPTION OF EMBODIMENTS

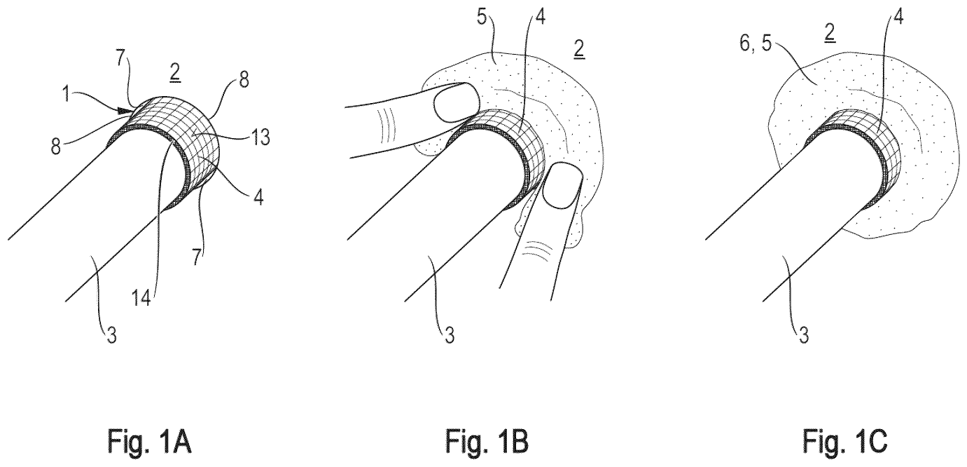

All of the various embodiments, variants and specific design features of the method according to the first and further aspects of the invention and the corresponding seal assembly mentioned above in the description and in the subsequent claims can be implemented in the examples shown in FIG. 1a to 3. They are therefore not all repeated again below. The same applies mutatis mutandis to the definitions of terms and effects already specified above in relation to individual features which are shown in FIG. 1a-3.

FIG. 1a to 1c show, in a perspective view, individual steps of a method according to the first aspect of the invention for sealing an opening 1 in a drywall 2 through which a thin pipe 3 (line) is passed.

First (not shown), a strip-shaped fire protection bandage 4, which in this example is a conventional fire protection bandage CFS-B, is reduced (cut) from approximately 125 mm to approximately 30 mm in width and cut to a length which corresponds to the circumference of the pipe 3.

As FIG. 1a shows, the cut-to-length fire protection bandage 4 is then placed around the pipe 3, such that a simple layer of the fire protection bandage 4 is formed on the pipe 3. The fire protection bandage 4 is applied to the pipe 3 such that a large part of the fire protection bandage 4, in particular at least half of the width thereof, is hidden within the opening 1 in the wall 2, and only the remaining width, in this example approximately 5 mm, protrudes from the opening 1.

As FIG. 1b and FIG. 1c show, a putty 5 is then annularly applied by hand to the part of the fire protection bandage 4 protruding from the opening 1 such that a putty ring 6 (in this example approximately in the shape of a disc or a circular ring, a regular shape not being important) having a slightly larger outer diameter than the opening diameter is formed or shaped by kneading. The putty ring 6 is shaped such that it closes the opening 1, i.e. the annular gap 7 between the pipe 3 and the opening edge 8, on the outside and extends slightly beyond the opening edge 8 in the wall 2. In other words, the putty ring 6 formed in this way covers the annular gap 7 and is pressed firmly against both the fire protection bandage 4 and the opening edge 8. The fire protection bandage 4 is thus fixed and the annular gap 7 is closed, i.e. sealed.

A putty 5 which is suitable for this purpose is ideally plastically deformable in order to be adaptable to the relevant individual shape of the annular gap 7 by kneading. The putty can also be dense and/or optionally can also be adhesive. In particular, said putty can be a permanently plastic butyl rubber mixture.

In order to improve the fire protection properties, the putty 5 can in particular also contain fire protection additives. The putty can, for example, be flame-retardant or intumescent, such that it foams up when exposed to heat and thus can close any defects in the opening 1 that arise in the event of a fire, for example as a result of a melting line.

FIG. 2 shows an example of a prefabricated seal assembly 9 of the type described herein for use in a method according to a further aspect of the invention. In order to produce the seal assembly 9, a conventional fire protection bandage 4 (type CFS-B) was reduced (cut) from approximately 125 mm to approximately 30 mm in width and cut to a length corresponding to the circumference of the line to be sealed (not shown) plus a slight overlap 10. The seal assembly 9 further comprises a putty strip 11 which extends along one of the two peripheral edges 12 of the fire protection bandage 4 and is applied to an outer surface 13 of the fire protection bandage 4 that is not intended to be placed on the line. In this example, this outer surface 13 is a woven fabric layer 13, to which a continuous fire protection wrap 14 made of an intumescent material is attached on the inside, which fire protection wrap is intended to abut the line. The putty strip 11 is formed from the same putty 5 as in FIG. 1a-1c.

In the prefabricated seal assembly 9 shown in FIG. 2, the cut-to-length fire protection bandage 4 provided with the putty strip 11 is rolled up to form a simple layer having an overlap 10, overlapping ends of the fire protection bandage 4 being attached to one another by additional putty 15.

FIG. 3 shows a further example of a prefabricated seal assembly 9a which additionally has a removable transport protection film 16 on the outside of the putty strip 11. In addition, the explanation with regard to FIG. 2 can also apply correspondingly with regard to FIG. 3. In the variant shown in FIG. 3, the prefabricated seal assembly 9a is not rolled up; however, this can optionally also take place here in a further production step.

By means of a prefabricated seal assembly 9 or 9a of FIG. 2 or 3, the sealing of a line feedthrough, for example on the pipe 3 of FIG. 1a, can be carried out in a single mounting step (OneStep) with a result as in FIG. 1c.

As proven by representative fire tests using a 100 mm thick drywall and hand-made prototypes, as shown in FIG. 1a to 3, the test target of up to EI 120 (according to EN fire resistance classes for integrity, heat barrier or thermal insulation under the influence of fire) is achieved for various pipe types having different diameters of between 16 mm and 32 mm, such as for
a PP-R Aquatherm pipe having a diameter of 20 mm and a wall thickness of 3.5 mm;
a PVC pipe having a diameter of 32 mm and a wall thickness of 3.6 mm;
a PVC pipe having a diameter of 25 mm and a wall thickness of 1.9 mm;
empty electrical conduits, flex, FFKu-EL-F having an unoccupied diameter of 25 mm;
a PE pipe having a diameter of 25 mm and a wall thickness of 1.8 mm.

The amount of intumescent material reduced according to the invention is therefore sufficient for these types of pipe. The function of the bandage in solid walls and ceilings should therefore be at least comparable. As the following calculation shows, a material saving of approx. 88% can be achieved in comparison with the analogous conventional installation solution using CFS-B, which is particularly resource-efficient (V_{CFS Calla} in this case denotes the volume of the fire protection bandage 4 cut to size according to the invention):

Exemplary calculation for the material consumption of the fire protection bandage 4 according to the present invention:

πD=U,U=78.5 mm for D=25 mm with 1 winding

Fire protection material: bandage 2 mm thick and 30 mm wide (measured in the longitudinal direction of the pipe)

→VCFS-Calla=U·2 mm·30 mm=4710 mm3

By contrast, in the case of a conventional fire protection bandage CFS-B, the following material consumption is obtained:

2 windings required, thickness 2 mm and width 125 mm (measured in the longitudinal direction of the pipe)

→VCFS-B=U·2(windings)·2 mm·125 mm=39250 mm3

→Saving 1−VCFS-CallaNCFS-B=1−0.12=0.88

In addition to the uses of the method according to the invention and the seal assembly according to the invention described herein by way of example, further uses for other installations such as aluminum composite pipes, insulated solar lines and climate splitting applications are also to be mentioned as possible examples. Furthermore, use in existing combination fire stop systems is also possible. Instead of the putty described, alternative building materials can also be used for sealing, provided that they can guarantee the required fire-resistant sealing.

1: A method for fire-resistant sealing of an opening in a wall or a ceiling, through which a line is passed, the method comprising:
cutting a strip-shaped fire protection bandage to a length which corresponds to a simple circumference of the line, with or without an overlap, the fire protection bandage comprising fire-retardant and/or intumescent material;
placing the cut-to-length fire protection bandage around the line, such that a layer of fire protection bandage is formed, optionally with an overlap, which layer only partially protrudes outward from the opening;
annularly applying a putty to a part of the fire protection bandage protruding from the opening, a putty ring of a slightly larger outer diameter than the opening diameter being formed, such that the putty ring closes the opening and extends slightly beyond an edge thereof, and pressing the putty ring against the fire protection bandage and against the opening edge to seal the line feedthrough.

2: A method for producing a seal assembly for fire-resistant sealing of an opening in a wall or ceiling, through which a line is passed, the method comprising:
cutting a strip-shaped fire protection bandage to a length which corresponds to a simple circumference of the line, with or without an overlap, the fire protection bandage comprising fire-retardant and/or intumescent material;
applying a putty strip along one of two edges of the cut-to-length fire protection bandage, which are intended to extend in the circumferential direction of the line, the strip of putty being pressed against or otherwise attached to the one of two edges on an outer surface of the fire protection bandage that is not placed on the line; and
optionally, applying a removable transport protection film to at least one surface of the putty strip and/or optionally, rolling up the fire protection bandage provided with the putty strip to form a simple layer having an overlap.

3: A method for fire-resistant sealing of a line feedthrough using a seal assembly produced from the method according to claim 2, the method for fire-resistant sealing comprising:
placing the seal assembly around the line, such that a layer of the fire protection bandage is formed on the line, optionally with an overlap, wherein a peripheral edge of the fire protection bandage that is provided with the putty strip protrudes outward from the opening;
removing the transport protection film, if necessary; and
shaping the putty strip to form a putty ring of a slightly larger outer diameter than the opening diameter, such that the putty ring closes the opening and extends slightly beyond an edge thereof, and pressing the putty ring formed in this way against the fire protection bandage and against the edge in order to seal the line feedthrough.

4: The method according to claim 1, wherein the line has a diameter in a range of between approximately 16 mm and approximately 32 mm.

5: The method according to claim 1, wherein the putty is
elastically and/or plastically deformable; and/or
dense; and/or
adhesive; and/or
formed as a crosslinked rubber-based rubber product; and/or
formed having fire protection additives.

6: The method according to claim 1, wherein the fire protection bandage has a flexible carrier layer, to which a fire protection wrap made of an intumescent material is attached.

7: The method according to claim 6, wherein the fire protection bandage, with the fire protection wrap thereof, is placed on the line, and the putty is placed on the carrier layer and pressed on.

8: The method according to claim 1, wherein the fire protection bandage is cut to a reduced width of approximately 30 mm before or after being cut to length.

9: The method according to claim 1, wherein the fire protection bandage protrudes approximately 5 mm outward from the opening after being placed around the line.

10: A seal assembly for fire-resistant sealing of an opening in a wall or ceiling, through which a line is passed, the seal assembly comprising:
a strip-shaped fire protection bandage having a length which corresponds to a simple circumference of the line, with or without an overlap, the fire protection bandage comprising fire-retardant and/or intumescent material;
a putty strip which extends along one of two peripheral edges of the fire protection bandage and is applied to an outer surface of the fire protection bandage that is not placed on the line; and
optionally, a removable transport protection film on at least one surface of the putty strip;
wherein the fire protection bandage provided with the putty strip is optionally rolled up to form a simple layer having an overlap.

11: The seal assembly according to claim 10, wherein the seal assembly is designed as a roll product.

12: The method according to claim 2, wherein the fire protection bandage provided with the putty strip is rolled up to form the simple layer having the overlap, and wherein overlapping ends of the fire protection bandage are temporarily attached to one another by some of the putty strip or by additional putty.

13: The method according to claim 6, wherein the flexible carrier layer is a woven fabric layer.

14: The method according to claim 6, wherein fire protection wrap is a continuous fire protection wrap.

15: The seal assembly according to claim 10, wherein the fire protection bandage provided with the putty strip is rolled up to form the simple layer having the overlap, and wherein overlapping ends of the fire protection bandage are attachable to one another by some of the putty strip or by additional putty.
